(19) United States
(12) Patent Application Publication
(10) Pub. No.: US 2022/0269021 A1
(43) Pub. Date: Aug. 25, 2022

(54) FIBER CARRYING STRUCTURE HAVING INDICIA INDUCED BY LASERS AND RELATED METHOD

(71) Applicant: Corning Research & Development Corporation, Corning, NY (US)

(72) Inventors: Barada Kanta Nayak, Painted Post, NY (US); Kenneth Darrell Temple, JR., Temple, NC (US); Craig John Mancusi Ungaro, Corning, NY (US)

(21) Appl. No.: 17/741,725

(22) Filed: May 11, 2022

Related U.S. Application Data
(63) Continuation of application No. PCT/US2020/060933, filed on Nov. 18, 2020.
(60) Provisional application No. 62/938,662, filed on Nov. 21, 2019.

(51) Int. Cl. G02B 6/44

(52) U.S. Cl. CPC G02B 6/443; G02B 6/4434; G02B 6/4482; G02B 6/4435; G02B 6/4494

(57) ABSTRACT

An optical fiber carrying structure that includes a jacket is provided. The jacket includes a primary body portion formed from a first polymer material and one or more marking regions formed from a second polymer material. Indicia are formed in at least one of the marking regions. The indicia are formed from a laser-induced change to the second polymer material exposing the first polymer material.

### PRIORITY APPLICATION

This application is a continuation of International Patent Application No. PCT/US2020/060933 filed Nov. 18, 2020, which claims the benefit of priority of U.S. Provisional Application No. 62/938,662, filed on Nov. 21, 2019, the content of which is relied upon and incorporated herein by reference in its entirety.

### BACKGROUND

The present invention is related to optical fiber carrying structures and more particularly to optical fiber carrying structures that have a jacket with a composition that facilitates laser printing on the jacket. Optical fiber cables are used to transmit data over distance. Generally, large distribution cables that carry a multitude of optical fibers from a hub are sub-divided at network nodes, which are further sub-divided, e.g., to the premises of individual subscribers. As the optical fibers are subdivided, the cables making up these subdivisions need to be identified by the technicians so that the cables can be appropriately routed.

### SUMMARY

In one aspect, embodiments of the disclosure relate to an optical fiber carrying structure that includes a jacket and an optical communication element. The jacket includes an inner surface, an outer surface, a primary body portion, a marking region, a plurality of apertures, an outermost surface of the jacket, and indicia. The inner surface defines a central bore that extends longitudinally between first and second ends of the jacket. The marking region is coupled to the primary body portion and extends longitudinally along the primary body portion. The plurality of apertures are formed within the marking region, and the primary body portion is exposed by the apertures. The outermost surface of the jacket is defined by an outer surface of the primary body portion and/or an outer surface of the marking region. The indicia are formed in the marking region by the plurality of apertures. The optical communication element is located within the central bore and extends longitudinally between the first and second ends of the jacket.

In another aspect, embodiments of the disclosure relate to an optical fiber carrying structure that includes a jacket and an optical communication element. The jacket includes an inner surface, an outer surface, an inner layer, an outer layer, a plurality of apertures, and indicia. The jacket extends longitudinally between first and second ends of the jacket. The inner layer has a first color and the outer layer has a second color. The outer layer is coupled to and circumferentially surrounds the inner layer. The plurality of apertures are formed in the outer layer, exposing the inner layer. The indicia are formed by a visual contrast between the second color of the outer layer and the first color of the inner layer exposed by the plurality of apertures in the outer layer. The optical communication element is located in the internal region of the jacket.

In yet another aspect, embodiments of the disclosure relate to a method of manufacturing an optical fiber carrying structure. The method includes moving an optical fiber carrying structure to a laser print head. The optical fiber carrying structure includes an optical communication element and a jacket that radially surrounds the optical communication element. The jacket includes a first material and a second material. The method further includes passing the jacket past the laser print head. The method further includes emitting a laser light from the laser print head onto the first material, which ablates the first material. The ablation of the first material forms a plurality of apertures through which the second material is exposed. The plurality of apertures form indicia by a visual contrast between a color of the first material and a color of the second material.

Additional features and advantages will be set forth in the detailed description that follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding and are incorporated in and constitute a part of this specification. The drawings illustrate one or more embodiment(s), and together with the description serve to explain principles and the operation of the various embodiments.

### BRIEF DESCRIPTION OF DRAWINGS

The accompanying drawings incorporated in and forming a part of the specification illustrate several aspects of the present invention and, together with the description, serve to explain the principles of the invention. In the drawings:

FIG. 1 depicts an optical fiber cable, according to an exemplary embodiment;

FIG. 2A depicts a detailed view of the optical fiber cable of FIG. 1, according to an exemplary embodiment;

FIG. 2B depicts another detailed view of the optical fiber cable of FIG. 1, according to an exemplary embodiment;

FIG. 2C depicts another detailed view of an optical fiber cable, according to an exemplary embodiment;

FIG. 3 depicts an optical fiber cable, according to an exemplary embodiment;

FIG. 4 depicts a partial schematic view of a processing line for manufacturing an optical fiber cable with laser-induced indicia, according to an exemplary embodiment;

FIG. 5 depicts a partial schematic view of a processing line for manufacturing an optical fiber cable with laser-induced indicia, according to another exemplary embodiment;

FIG. 6 depicts a partial schematic view of a processing line for manufacturing an optical fiber cable with laser-induced indicia, according to another exemplary embodiment; and

FIG. 7 depicts an optical fiber cable, according to an exemplary embodiment.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION

Referring generally to the figures, various embodiments of an optical fiber carrying structure are disclosed in which a cable layer, such as a cable jacket or ribbon matrix, includes indicia formed via laser marking. A worker installing or maintaining an optical fiber carrying structure (e.g., cable, bundle, ribbon, buffer tube, micromodule, etc.) may want to identify a specific structure or subunit, such as for routing a cable to a desired destination. Labeling an optical fiber carrying structure facilitates how quickly the worker can identify a specific carrying structure.

In one embodiment the layer includes a primary body portion and a marking portion. When a laser is projected on the marking portion then indicia are produced. In some embodiments, indicia are formed by a visual contrast resulting from the laser forming a series of holes in the marking portion so that the underlying primary body portion is visible. For example, if the marking portion is a light color, such as white, and the primary body portion is a darker color, such as black, a visual contrast is formed between the white marking portion and the black primary body portion visible through the series of holes in the marking portion.

In another embodiment the jacket includes an inner layer and an outer layer that circumferentially surrounds the inner layer. When a laser is projected on the outer layer then indicia are produced. In some embodiments, indicia are formed by a visual contrast resulting from the laser forming a series of apertures in the outer layer so that the underlying inner layer is visible. For example, if the outer layer is a light color, such as white, and the inner layer is a darker color, such as black, a visual contrast is formed between the white outer layer and the black inner layer visible through the series of holes created by the laser.

Applicant has found that the laser marked cable structures and methods discussed herein provide a variety of improvements over prior cable marking technologies. As compared to cable manufacturing processes utilizing hot foil print techniques to form cable indicia, laser printing is more efficient and allows for easy edits/changes to the print strings. As compared to cable manufacturing processes utilizing ink jet print techniques to form cable indicia, the laser induced indicia are resistant to damage, scuffing, etc. because they are formed from changes to the cable material, rather than through addition of an ink layer.

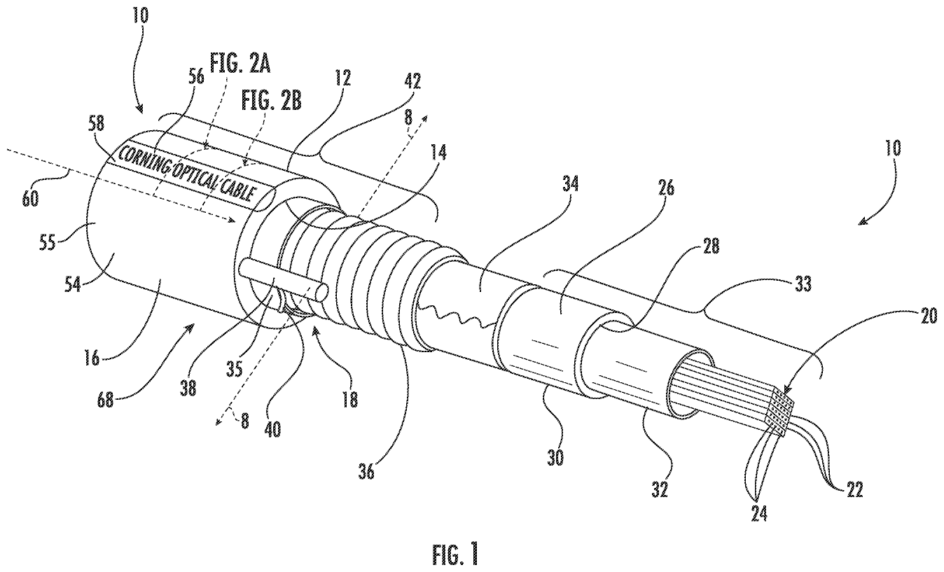

FIG. 1 depicts an embodiment of an optical fiber carrying structure, shown as cable 10. The optical fiber cable 10 includes a jacket, shown as outer cable jacket 12 having an inner surface 14 and an outer surface 16. The outer surface 16 defines an outermost surface of the optical fiber cable 10. The inner surface 14 of the cable jacket 12 defines a longitudinal bore 18. Disposed within the bore 18 are optical communication elements. In the embodiment depicted, the optical communication elements include a stack 20 of optical fiber ribbons 22. Each optical fiber ribbon 22 includes a plurality of optical fibers 24 arranged in a planar configuration and bound together, e.g., with a matrix material. In embodiments, the stack 20 includes various numbers of ribbons 22, e.g., from one to thirty-two optical fiber ribbons 22. In embodiments, each optical fiber ribbon 22 includes from four to thirty-six optical fibers 24. Thus, in embodiments, the optical fiber cable 10 may include varying numbers of optical fibers 24 in bore 18, e.g., anywhere from four to 3456 optical fibers 24 in the bore 18. In other embodiments, the optical fibers 24 may be in a loose-tube configuration or arranged in a plurality of buffer tubes, e.g., wound around a central strength member.

In the embodiment depicted in FIG. 1, the stack 20 of optical fiber ribbons 22 are contained in a buffer tube 26. The buffer tube 26 has an interior surface 28 and an exterior surface 30. In embodiments, disposed on the interior surface 28 and/or wrapped around the stack 20 is a water barrier layer 32 that prevents or limits water from contacting the optical fiber ribbons 22. In embodiments, the water barrier layer 32 is a water-blocking tape, e.g., that absorbs water and/or swells when contacted with water. In other embodiments, the water barrier layer 32 is an SAP powder applied to the exterior of the stack 20 and/or the inner surface 28 of the buffer tube 26. As used herein, all of the components from the buffer tube 26 inward are referred to as the “cable core” 33.

As shown in FIG. 1, a layer or strips of water-blocking tape 34, shown as swell tape, are applied along at least a portion of the cable 10. In the embodiment depicted in FIG. 1, the water-blocking tape 34 is positioned between an armor layer 36 and the buffer tube 26. In embodiments, the armor layer 36 is corrugated. In embodiments, the water-blocking tape 34 expands, which enhances the volume-filling effect of the water-blocking tape 34. The optical fiber cable 10 may include other components, such as longitudinal strength members 38 and/or preferential access features 40, such as a ripcord. The components of the optical fiber cable 10 outside of the water-blocking tape 34 (e.g., the cable jacket 12, the armor layer 36, adhesive 35, and the strength members 38 in the embodiment of FIG. 1) are referred to as the “jacket structure” 42. The components of the jacket structure 42 are closely coupled (e.g., the cable jacket 12 is extruded around the armor layer 36 and the strength members 38 are embedded in the cable jacket 12), which means that these components contract and expand during thermal cycling effectively the same amount. Armor layer 36 generally provides an additional layer of protection to fibers 24 within cable 10, and may provide resistance against damage (e.g., damage caused by contact or compression during installation, damage from the elements, damage from rodents, etc.). In various embodiments, armor layer 36 may be formed from a variety of strengthening or damage resistant materials. In various embodiments adhesive 35 circumferentially surrounds armor layer 36.

As shown, cable 10 includes a marking region 56. Marking region 56 is coupled to primary body portion 54 and extends along primary body portion 54 in longitudinal direction 60. As shown in FIG. 1, outer surface 16 of jacket 12 is defined by outer surface 55 of primary body portion 54 and outer surface 58 of marking region 56. In a specific embodiment outer surface 55 and outer surface 58 are circumferentially flush with respect to each other. Marking region 56 includes indicia 62 that is used to identify cable jacket 12. In the embodiment shown, cable jacket 12 is the outer jacket of cable 10 and consequently defines outer-most surface 68 of cable 10. In various embodiments, the marking regions and indicia discussed herein may be located on other jacket layers within an optical fiber carrying structure, such as on internal cable jackets, micromodule jackets, buffer tubes, sleeves, bundle jackets, etc.

In one embodiment primary body portion 54 is formed from a first polymer material, while marking region 56 is formed from a second polymer material. In a specific embodiment, primary body portion 54 and first marking region 56 are formed from the same polymer material with the exception that an additive is added to at least one of primary body portion 54 and/or first marking region 56 so that they have a different coloring (e.g., the first polymer material is black and the second polymer material is white). In another specific embodiment, the first polymer material and the second polymer material are different polymers.

In various embodiments, jacket 12 (e.g., including body portion 54 and marking region 56) is formed from a polymer material and in specific embodiments is formed from a polyolefin material. Exemplary polyolefins suitable for use in the jacket 12 include one or more of medium-density polyethylene (MDPE), high-density polyethylene (HDPE), low-density polyethylene (LDPE), linear low-density polyethylene (LLDPE), and/or polypropylene (PP), amongst others. Exemplary thermoplastic elastomers suitable for use in the jacket 12 include one or more of ethylene-propylene rubber (EPR), ethylene-propylene-diene rubber (EPDM), ethylene-octene (EO), ethylene-hexene (EH), ethylene-butene (EB), ethylene-vinyl acetate (EVA), and/or styrene-ethylene-butadiene-styrene (SEBS), amongst others.

In some embodiments, indicia 62 are formed from a laser-induced change to marking region 56. In one example, the laser-induced change is a physical change to the structure of marking region 56, such as forming one or more apertures within marking region 56 so that primary body portion 54 is exposed (e.g., visible to the unaided human eye) through the one or more apertures. As a result of the apertures, a visual contrast is formed between the color of the marking region 56 and the color of the underlying primary body portion 54 visible through the apertures in the marking region 56.

In a specific embodiment, one or more characters in indicia 62 (e.g., “C”, “O”) are formed via a contiguous aperture in marking region 56 that exposes primary body portion 54 via a laser aimed at locations that are 20 microns apart. In another specific embodiment, one or more characters in indicia 62 (e.g., “C”, “O”) are formed via a contiguous aperture in marking region 56 that exposes primary body portion via a laser continuously carving marking region 56. In another specific embodiment, characters in indicia 62 are formed via placement of apertures 82 via the laser in a pattern, such as dot-matrix that is 7 dots tall and has a pitch of 300 microns between lines of dots.

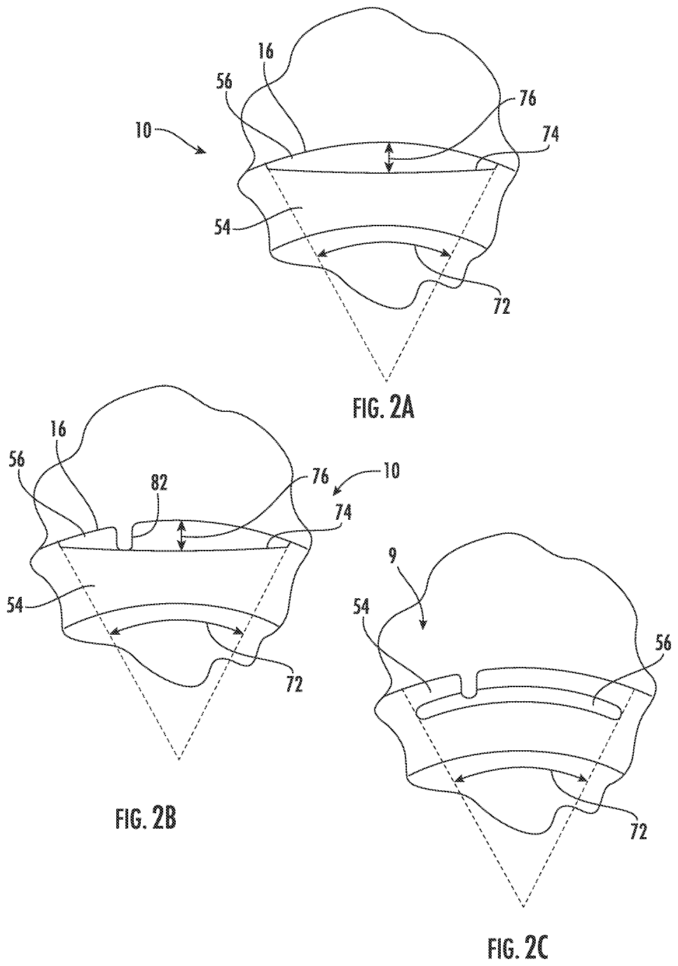

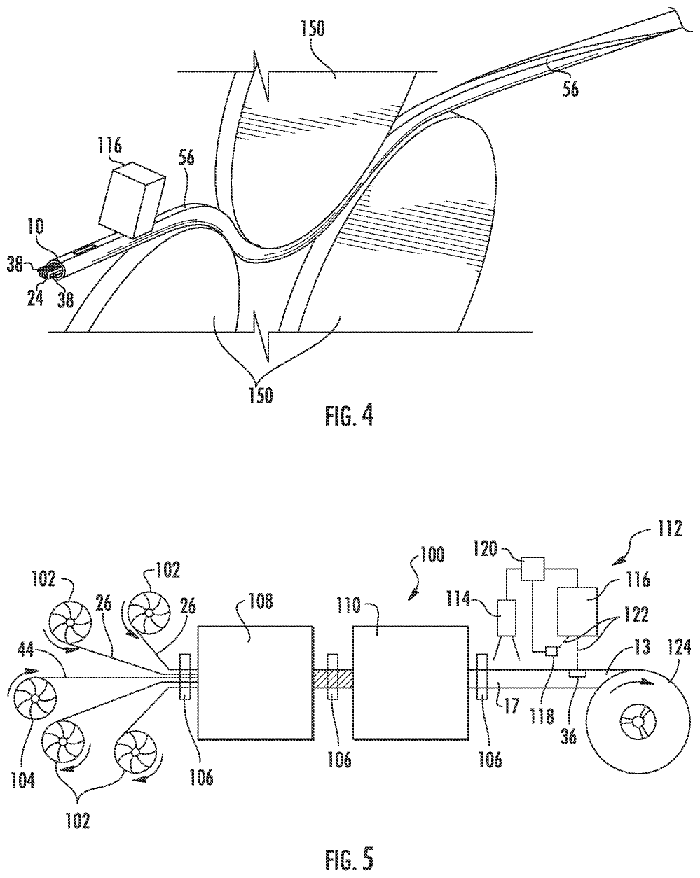

FIGS. 2A and 2B depict detailed views of optical cable 10. As a result of the positioning of strength members 38 in cable 10, cable 10 bends along axis 8, which is perpendicular to longitudinal direction 60. In the embodiment shown in FIGS. 2A and 2B, the center of marking region 56 is located 90 degrees circumferentially away from strength members 38 and thus bend axis 8. In various embodiments, marking regions 56 extends longitudinally along jacket 12 in substantially a straight line such that the circumferential positioning of marking region 56 with respect to strength members 38 is constant along the length of cable jacket 12. This constant circumferential positioning of marking regions 56 with respect to jacket 12 and strength members 38 facilitates using the preferential bend access to bend cable 10 to locate marking region 56 without having to visually search for it during laser marking (described below in FIG. 4).

In various embodiments, marking region 56 defines an arc length that extends through a circumferential angle of 150 degrees or less, or more specifically 120 degrees or less, or even more specifically less than 90 degrees, or even more specifically 80 degrees. In accordance with aspects of the present disclosure, marking region 56 defines an arc length 72 that extends through a circumferential angle of 30-120 degrees, and more specifically 60-120 degrees, and even more specifically of 60-100 degrees, and even more specifically 70-90 degrees.

In accordance with yet other aspects of the present disclosure, characters in indicia 62 have a height between 3 and 5 mm, and more particularly indicia 62 have a height of 5 mm. FIG. 2B depicts aperture 82 within marking region 56. Aperture 82 was formed by a laser process according to aspects of the present disclosure as described herein and caused by creating the character “L” shown in FIG. 1. In a specific embodiment, marking region has a maximum thickness 76 between 5 microns and 100 microns, and more particularly between 10 microns and 40 microns, and more particularly 20 microns.

In FIG. 2B, aperture 82 extends to and is delimited by the outermost surface of primary body portion 54. In alternate embodiments the aperture will extend partially into the underneath layer, which in FIG. 2B is primary body portion 54, such as is shown in FIG. 2C.

FIG. 2C depicts a detailed view of optical cable 9. Cable 9 is substantially the same as cable 10 except for the differences discussed herein. In FIG. 2C, primary body portion 54 circumferentially surrounds marking region 56. Similar to other embodiments, marking region 56 in FIG. 2C is exposed when an aperture extends through primary body portion 54 to expose marking region 56. In the embodiment shown in FIG. 2C, a portion of marking region 56 has been partially removed due to laser, and thus the aperture in FIG. 2C is created by the removal of both primary body portion 54 and marking region 56. In one or more embodiments cable 9 is a preferential bend cable, and the center of marking region 56 is located 90 degrees from the preferential bend access, thus facilitating positioning marking region 56 in cable 9 similar to how marking region 56 is positioned in cable 10.

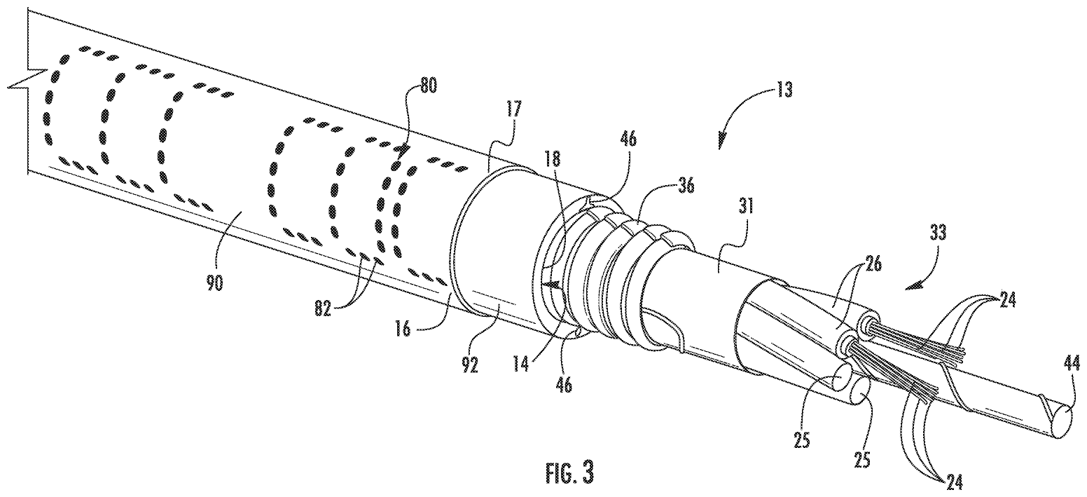

Referring to FIG. 3, cable 13 includes a plurality of core elements located within central bore 18. Cable 13 is substantially the same as cable 10 except for the differences discussed herein. Further, details of cable jacket 17 and laser marked indicia 62 provided herein are discussed in relation to FIG. 3, with the understanding that cable jacket 17 can be used with a wide variety of optical fiber cables, such as cable 10 and cable 13.

Jacket 17 of cable 13 comprises inner layer 92 and outer layer 90. Outer layer 90 circumferentially surrounds inner layer 92. In a specific embodiment, outer layer 90 is a first color and inner layer 92 is a second color. After apertures 82 are formed in outer layer 90, inner layer 92 is exposed. A visual contrast is created between the first color of outer layer 90 and the second color of inner layer 92 visible through apertures 82. As shown in FIG. 3, indicia 62 are formed via a dot-matrix style of printing.

A first type of core element is an optical transmission element, such as an optical fiber, which may be in the form of one or more loose fibers and/or fibers arranged in a planar array and connected by a matrix material to form one or more ribbons. As shown in FIG. 3, the optical transmission element may include one or more optical fibers 24 that are located within tubes, such as buffer tubes 26. One or more additional core elements, shown as filler rods 25, may also be located within bore 18. In the embodiment shown, filler rods 25 and buffer tubes 26 are arranged or wrapped around a central support, shown as central strength member 44 formed from a material such as glass-reinforced plastic or metal (e.g., steel). Together, buffer tubes 26 containing optical fibers 24, filler rods 25 and central strength member 44 form the core 33 of cable 13. In various embodiments, core 33 may include any type of optical core element in any combination including optical micro-modules, fiber optic subunits, bundles of fiber optic subunits, tight buffered optical fibers, filler tubes, etc.

In various embodiments, such as shown in FIG. 3, cable 13 includes a variety of additional layers or structures located within bore 18 between core 33 and inner surface 14. For example, a water blocking material, such as water barrier tape 31, may be located around the wrapped buffer tubes 26 and filler rods 25. Cable 13 also includes a reinforcement sheet or layer, shown as armor layer 36, which is located outside of water barrier 31. Armor layer 36 is wrapped around the interior elements (including optical fibers 24) of cable 13 such that armor layer 36 surrounds optical fibers 24 within bore 18. In various embodiments, cable jacket 17 may include one or more discontinuity, such as co-extruded discontinuities 46, embedded in cable jacket 17. In general, discontinuities 46 provide a weakened area in jacket 17 that allows the user to peel open jacket 12 in order to access core 33.

Cable jacket 17 includes an area to receive label markings, shown as label area 80. Within label area 80, markings, shown as laser formed apertures 82, are formed on outer surface 16. As explained in more detail below, apertures 82, are laser formed marks formed using a high-speed laser marking system.

Turning to FIGS. 4-6, described herein are several methods of generating indicia 62 on cables 10 and 13. It will be appreciated that the specific cables 10 and 13 referenced in FIGS. 4-6 are for illustrative purposes and that the methods described herein may be used with any suitable cable.

Referring to FIG. 4, according to a method of generating indicia 62, preferential-bend cable 10 is passed through one or more arcs, shown as wheels 150. As noted in FIGS. 2A and 2B, marking region 56 on preferential bend cable 10 is located 90 degrees from the preferential bend access 8. By bending a preferential bend cable 10 in FIG. 4 over wheels 150, the preferential bend of cable 10 ensures that marking region 56 faces away from wheel 150 and toward laser marking device 116.

In one embodiment, cable 10 is passed through a multiple wheel 150 deflection systems (e.g., a three wheel deflection system as shown) both before and after printing indicia 62. This arrangement maintains a biasing alignment on cable 10 throughout the printing process, thus reducing the likelihood that cable 10 will become misaligned while passing by the printer.

Referring to FIG. 5, according to another method of generating indicia 62, marking system 112 includes a vision system 114, a laser marking device 116, a laser position sensor 118 and a controller 120. In general, vision system 114 detects marking region 56 to generate a signal indicative of the position and/or speed of label area 80. The signal from vision system 114 is communicated to controller 120, and controller 120 sends a control signal to laser marking device 116 in order to generate the desired markings (e.g., laser formed apertures 82 shown in FIG. 5) based on the signal from vision system 114. In various embodiments, to form the desired laser markings at the high throughput speeds discussed herein, laser marking device 116 is configured to aim, reflect or otherwise change the direction of a generated laser at high speeds, and in various embodiments, this control may be based on the positional information from vision system 114. In various embodiments, as discussed in more detail below, laser marking device 116 is configured to change the path of the generated laser at least 2000 times per second. Further, it should be understood that marking system 112 may be used to mark any moving surface of a fiber optic formation system, including but not limited to, outer surfaces of buffer tubes 26, outer surfaces of tight buffered optical fibers, outer surfaces of optical fiber micro-modules, outer surfaces of optical fiber subunits, outer surfaces of fiber optic ribbons, etc.

In addition, as explained in more detail below, marking system 112 includes a laser position sensor or position sensitive detector 118 (“PSD 118”) that is configured to detect the position of laser light, shown as laser beam 122, generated by laser marking device 116. In some embodiments, laser position sensor 118 may be located within the path of laser beam 122 as it travels onto outer surface 16 of cable jacket 17. In another embodiment, laser position sensor 118 may be located elsewhere, and laser marking system 112 is configured to periodically direct, reflect or aim laser beam 122 onto laser position sensor 118. In various embodiments, laser position sensor 118 generates a signal indicative of laser positioning and communicates this signal to controller 120. In various embodiments, controller 120 generates a control signal to laser marking system 116 based on the laser positioning information to control operation of laser marking system 116 to ensure that the laser formed indicia (e.g., apertures 82) are being formed at the appropriate location on outer surface 16. Following formation of the laser markings, cable 13 may then be stored on a reel 124

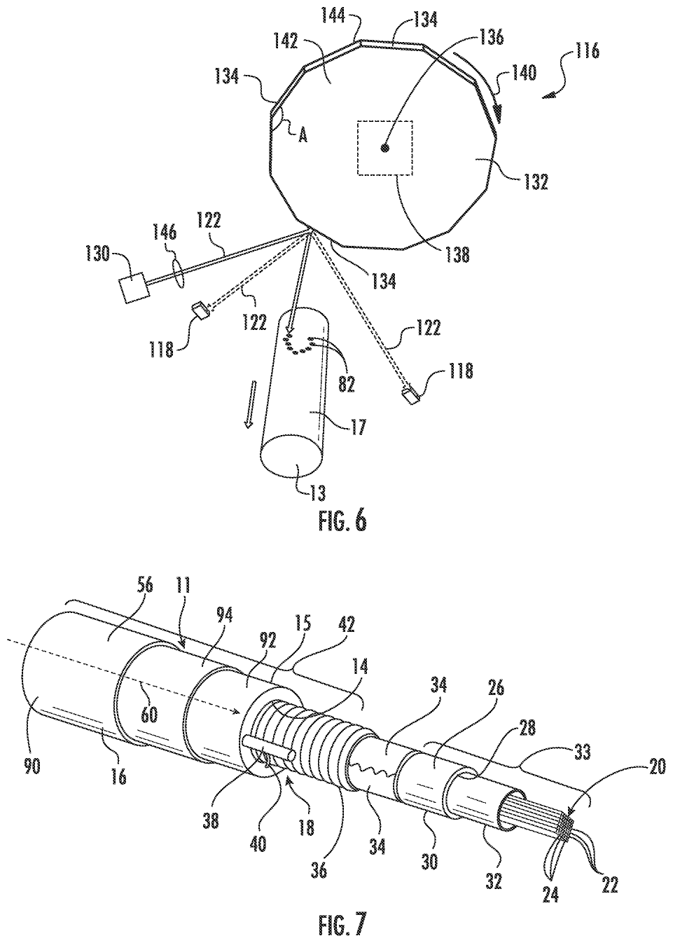

Referring to FIG. 6, laser marking device 116 is shown in more detail according to an exemplary embodiment. Laser marking device 116 includes a laser generating device, shown as laser device 130, that is configured to generate laser beam 122 of an intensity and/or wavelength that allows for the formation of apertures 82 on cable jacket 17. In various embodiments, laser device 130 is a laser operating at a highly absorbable wavelength for material of cable jacket 17. In various exemplary embodiments, laser device 130 is a CO2 laser operating at wavelengths ranging from 9 μm to 11 μm, and in other embodiments, may be other types of lasers with wavelengths range from 200 nm to 8000 nm. In a specific embodiment, laser device 130 is a solid-state laser with a pulse energy of 100 micro Joules, a repetition rate of 50 kHz, a pitch of 20 microns, and a beam width of 1/(e\hat{ }2). In another embodiment, laser device 130 has a faster repetition rate.

Laser marking device 116 includes a laser directing device, shown as mirror 132. In general mirror 132 includes a plurality of reflective surfaces or facets 134. In the embodiment shown, each reflective facet 134 is a substantially planar facet that is located at an angle A, relative to the adjacent facets. In the embodiment shown angle A is greater than 90 degrees and less than 180 degrees, and is proportional to the number of facets 134. Mirror 132 is rotatably coupled to an axle 136 and a motor 138. Motor 138 is configured to spin mirror 132 continuously in one direction represented by arrow 140, and in this arrangement, as mirror 132 spins, facets 134 travel in a path in the direction of arrow 140 that circumscribes axle 136. As mirror 132 rotates around axle 136, the angle of reflection of laser beam 122 off of reflective facet 134 changes, and this changing angle of reflection in turn directs laser beam 122 onto different, discrete locations on outer surface 16, as cable jacket 17 moves through the laser marking station. In addition to allow laser beam 122 to periodically interact with laser position sensors 118, laser beam 122 is also directed toward position sensors 118 at various rotational positions of mirror 132. In general, because mirror 132 spins in a single direction and thus eliminates the deceleration and direction reversals used in some galvanometer-based laser marking systems, laser marking device 116 is able to operate at a much faster marking rate than typical laser marking systems.

In the specific embodiment shown, mirror 132 is a polygonal shaped mirror having a first major surface 142, and a second major surface opposing first major surface 142. In this embodiment, reflective facets 134 are formed along a peripheral edge surface 144 that extends between the opposing major surfaces. In this embodiment, peripheral edge surface 144 and reflective facets are substantially perpendicular to the first and second major surfaces, and axle 136 and the respective axis of rotation is substantially perpendicular to the first and second major surfaces.

Laser marking device 116 may also include one or more optical lens 146 located along the path of laser beam 122 between laser device 130 and cable jacket 17. In general, optical lens 146 focuses laser beam 122 so that its power intensity is well suited for making apertures 82 of a relatively small size on cable jacket 17. In various embodiments, optical lens 146 can be either located between mirror 132 and laser device 130 or after between mirror 132 and cable jacket 17. In general the positioning of optical lens 146 is determined based on various factors including the physical arrangement of system 100, the desired pixel size, power intensity of laser device 130, processing throughput speed, etc. It should be understood that laser marking device 116 may include various components or arrangements to mitigate the contamination of optical components, such as the use of a vacuum nozzle, positioning the optical lens in a distant location from cable 10 and/or providing the optical lenses with various optical coating to reduce potential damage.

As noted above, in order to form apertures 82 at high rates of speed, laser beam 122 must be directed to distinct positions on the outer surface of cable jacket 12 at high rates of speed. In the embodiment shown in FIG. 6, the speed at which laser beam 122 is directed to distinct points is based at least on the size and position of reflective facets 134 and the rotational speed of mirror 132. In various embodiments, rotational motor 138 is configured to spin mirror 132 at a rotational speed equal to or greater than 2000 rpm, and specifically at a rotational speed equal to or greater than 4000 rpm, and in specific embodiments, at a rotational speed between 2000 rpm and 50,000 rpm. In particular embodiments, marking system 112 discussed herein may be used to form symbols or characters within a size range of 2 mm to 8 mm.

Referring to FIG. 7, cable 11 includes a plurality of core elements located within central bore 18. Cable 11 is substantially the same as cable 9, cable 10 and cable 13 except for the differences discussed herein. Further, details of cable jacket 15 and laser marked indicia 62 provided herein are discussed in relation to FIG. 7, with the understanding that cable jacket 15 can be used with a wide variety of optical fiber cables, such as cable 10 and cable 13.

Cable jacket 15 comprises inner layer 92, which is circumferentially surrounded by middle layer 94, which is circumferentially surrounded by outer layer 90. In a specific embodiment apertures 82 are formed through outer layer 90 and middle layer 94 to expose inner layer 92, with inner layer 92 having a different color than outer layer 90 to present a visual contrast by which indicia 62 are formed. In another specific embodiment, each of outer layer 90, middle layer 94, and inner layer 92 have differing colors such that apertures 82 transiting at least one of outer layer 90 and middle layer 94 will create a visual contrast via the different color between outer layer 90 and one or both of middle layer 94 and inner layer 92. In a specific, middle layer 94 and outer layer 90 have a thickness between 5 microns and 100 microns, and more particularly between 10 microns and 40 microns, and more particularly 20 microns.

In one embodiment, multiple laser marking devices 116 (e.g., 2 or more) are circumferentially placed around the cable. A circumferentially placed vision system 114 detects which of the multiple laser marking devices 116 are in proper alignment (or require the least adjustment to a proper position) and the appropriate laser marking device 116 receives a signal to print indicia 62.

In one specific embodiment, inner layer 92 is more heat-resistant than outer layer 90 (e.g., the inner layer is more heat-conductive, the inner layer absorbs more heat before a phase change). In another specific embodiment, inner layer 92 and middle layer 94 are both more heat-resistant than outer layer 90. In another specific embodiment, primary body portion 54 has a different heat-resistance than marking region 56.

In another specific embodiment, inner layer 92 is more laser-resistant than outer layer 90. For example, inner layer 92 is more laser-reflective than outer layer 90. As a result, less energy is absorbed by inner layer 92 than would be absorbed by outer layer 90 when similar levels of laser light are emitted on them. In another specific embodiment, primary body portion 54 has a different laser-resistance than marking region 56.

In one or more embodiments the aperture, such as aperture 82 generated by a laser, extends partially into the underneath material layer, such as is shown in FIG. 2C. Alternately, one or more of the apertures may be defined in part by the outermost surface of the underneath material layer, such as is shown in FIG. 2B.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An optical fiber carrying structure comprising:
a jacket comprising a first inner surface and an outer surface, the first inner surface defining a central bore extending in a longitudinal direction between first and second ends of the jacket, the jacket comprising:
a primary body portion;
a marking region, the marking region coupled to the primary body portion and extending along the primary body portion in the longitudinal direction;
a plurality of apertures formed within the marking region through which the primary body portion is exposed;
an outermost surface of the jacket that is defined by at least one of an outer surface of the primary body portion and an outer surface of the marking region; and
indicia formed in the marking region, wherein the indicia is formed via the plurality of apertures; and
an optical transmission element located within the central bore and extending in the longitudinal direction between the first and second ends of the jacket.

2. The optical fiber carrying structure of claim 1, wherein the outermost surface of the jacket is defined by both the outer surface of the primary body portion and the outer surface of the marking region.

3. The optical fiber carrying structure of claim 2, wherein the optical fiber carrying structure comprises a preferential bend axis, and wherein the circumferential positioning of the marking region with respect to the bend axis is constant along the length of the jacket.

4. The optical fiber carrying structure of claim 2, wherein the primary body portion has a first color, and wherein the marking region has a second color, and wherein the indicia is further formed by a visual contrast between the first color of the marking region and the second color of the primary body portion that is exposed via the plurality of apertures in the marking region.

5. The optical fiber carrying structure of claim 2, wherein the marking region that extends through a circumferential angle of between 60 and 100 degrees.

6. The optical fiber carrying structure of claim 1, wherein the plurality of apertures comprises a first aperture, and wherein the first aperture consists of a single aperture within the marking region that forms an entire letter of the indicia.

7. The optical fiber carrying structure of claim 1, wherein the jacket is an outer jacket, and wherein the outermost surface of the jacket defines an outer surface of the optical fiber carrying structure.

8. The optical fiber carrying structure of claim 1, wherein the plurality of apertures comprise a plurality of dots arranged in a pattern within the marking region to form a character.

9. The optical fiber carrying structure of claim 1, wherein the indicia comprises a circumferential length of 3 mm to 5 mm.

10. An optical fiber carrying structure comprising:
a jacket comprising a first inner surface and an outer surface, the first inner surface defining an internal region extending in a longitudinal direction between first and second ends of the jacket, the jacket comprising:
an inner layer having a first color;
an outer layer coupled to the inner layer and circumferentially surrounding the inner layer, the outer layer having a second color;
a plurality of apertures defined by the outer layer through which the inner layer is exposed; and
indicia formed from a visual contrast between the second color of the outer layer and the first color of the inner layer that is exposed via the plurality of apertures in the outer layer; and
an optical communication element located in the internal region of the jacket.

11. The optical fiber carrying structure of claim 10, wherein the outer layer is formed from a first material and the inner layer is formed from a second material, and wherein the second material of the inner layer is more heat-resistant than the first material of the outer layer.

12. The optical fiber carrying structure of claim 10, wherein the plurality of apertures comprises a first aperture, and wherein the first aperture consists of a single aperture within the outer layer that forms an entire letter of the indicia.

13. The optical fiber carrying structure of claim 10, wherein the jacket is an outer jacket, and wherein the outer surface of the jacket defines an outermost surface of the optical fiber carrying structure.

14. The optical fiber carrying structure of claim 10, wherein the plurality of apertures form a character via a dot-matrix.

15. A method of manufacturing an optical fiber carrying structure, the method comprising:
moving an optical fiber carrying structure to a laser print head, the optical fiber carrying structure comprising an optical communication element and a jacket that radially surrounds the optical communication element, the jacket comprising a first material and a second material;
passing the jacket past the laser print head; and
emitting a laser light from the laser print head onto the first material thereby ablating the first material to form a plurality of apertures in the first material through which the second material is exposed, wherein the plurality of apertures form indicia that is visible due to a visual contrast between a color of the first material and a color of the second material.

16. The method of claim 15, wherein the plurality of apertures comprises a first aperture, and wherein the first aperture consists of a single aperture that forms an entire letter of the indicia.

17. The method of claim 15, wherein ablating the first material comprises transforming at least a portion of the first material into a gas.

18. The method of claim 15, wherein the first material circumferentially surrounds the second material.

19. The method of claim 18, wherein the jacket further comprises a third material that circumferentially surrounds the first material, and wherein emitting the laser light also ablates a portion of the third material.

20. The method of claim 15, wherein the first material defines a marking region that extends longitudinally along the jacket, and wherein the second material defines a primary body portion of the jacket, and wherein an outermost surface of the jacket is defined by both the outer surface of the primary body portion and the outer surface of the marking region.
